(19) United States
(12) Patent Application Publication
(10) Pub. No.: US 2010/0067674 A1
(43) Pub. Date: Mar. 18, 2010

(54) MESSENGER SYSTEM FOR TRANSMITTING HANDWRITING INSTANT MESSAGES THROUGH WIRE AND/OR WIRELESS NETWORK SYSTEM AND MESSENGER SERVICE METHOD THEREOF

(76) Inventor: Yong-Jik Lee, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 12/513,126

(22) PCT Filed: Nov. 1, 2007
(86) PCT No.: PCT/KR07/05501

§ 371 Date: Apr. 30, 2009

(30) Foreign Application Priority Data
Nov. 1, 2006 (KR) 10-2006-0107113

(51) Int. Cl. H04M 11/00; H04W 4/12; G06F 3/033

(52) U.S. Cl. 379/100.01; 455/466; 345/179; 379/373.02; 455/567

(57) ABSTRACT

Disclosed are a wire and/or wireless handwriting instant messenger system and a method for realizing the same. In the wire and/or wireless handwriting instant messenger system, handwritten input information created in a handwritten input information generator is transmitted from a transmission terminal through a wire/wireless network, and received in a reception terminal, thereby allowing users to make communication with each other.

### TECHNICAL FIELD

The present invention relates to an instant messenger system and a service method thereof, capable of effectively transmitting a handwritten instant message between various wire/wireless terminals having various display standards under wire and/or wireless network environment. Particularly, the present invention is characterized in that information about a handwritten message created by using an ultrasonic wave is freely displayed, stored, or edited in various wire/wireless terminals and then transmitted to a reception terminal through a server cooperating with a wireless/wire network so that the information can be freely displayed, stored, or managed in the reception terminal regardless of a display standard of the reception terminal.

### BACKGROUND ART

Generally, an instant messenger service has been recognized as a very convenient service because it enables data communication with the counterpart in real time by calling the counterpart through simple manipulation based on access information for the counterpart, which is set at the initial stage, without performing a complicated procedure of individually inputting an e-mail address or a phone number of the counterpart to transfer messages to the counterpart.

Furthermore, recently, a user interface employing a handwriting scheme has been introduced into the instant messenger service, so that the problem of a typical text-based instant messenger service, which restricts intuitive and free expression using drawings or numerical formulas, can be remarkably solved.

However, when the instant messenger service is provided between wire/wireless terminals, particularly, when a mobile instant messenger service is provided between portable terminals, a user can input only a text through a push-button key pad or a QWERTY key pad, so that difficulties exist in the expression using drawings or numerical formulas.

Although there exist PDAs or smart phones equipped with a touch screen to enable handwritten input, they have not been popularized yet as compared with a typical handheld phone. In addition, although a handwriting input function exists, a wire and/or wireless instant messenger service system that can freely transmit/receive handwritten input information regardless of a wire/wireless terminal and a network environment is not provided yet.

Meanwhile, although a present wireless network technology has been developed so that large-capacity information such as moving pictures and music files can be sufficiently transmitted, the advance of the wireless network technology is stopped at the level of a short message service (SMS), which is a typical message transmission scheme, due to restriction of input devices of a wireless portable terminal.

As a result of advance in the ultra-high speed wireless network technology and the expanded distribution of camera phones, a multimedia message service (MMS) has been rapidly spread as a communication method, in which a user can conveniently make sufficient expression based on images. FIG. 1 is a block diagram schematically showing a conventional MMS.

The MMS has a main characteristic of transmitting an image taken by a photographing module 110 of a portable terminal to a reception terminal through an MMS server 220. The MMS allows a transmitter to deliver contents in the form of a photograph image so that the transmitter can make expression variously.

In such a conventional MMS scheme, the contents to be delivered are photographed by the photographing module 110 and then transmitted to the counterpart through the MMS server 220. At this time, the image of the contents is transformed by the MMS server 220 in accordance with the size and resolution, which have been previously standardized by a communication provider. However, in the case of a memo or handwritten information, the image must be precisely expressed without distorting or damaging detailed information thereof in order to accurately deliver the intention of a transmitter. In this case, the photographing module 110 must have high resolution, and a large-capacity (big sized) file having high resolution must be transmitted, so that a user has to pay a high communication fee. Accordingly, the MMS scheme is unsuitable under an existing network environment.

In particular, when an image is transmitted to a cable-based reception terminal, a representative of which is a personal computer (PC) having high display and resolution specifications, the MMS server 220 transforms the image under the standardization suitable for a portable terminal environment by taking a restricted display environment of a typical portable terminal into consideration, and then transmits the transformed image to the counterpart. For this reason, even if the PC which serves as a receiver has a superior display environment and a high resolution supporting function, the PC cannot sufficiently reproduce detailed expression intended by the transmitter.

### DISCLOSURE

### Technical Problem

In order to solve the above problems, the present invention provides a messenger system and a method for realizing the same, in which handwritten input information created by a user using an electronic pen is displayed through a display of a transmission terminal such that the information can be edited or stored, and then the handwritten input information is transmitted to a reception terminal such as a portable phone or a PC through a server so that the handwritten input information can be transmitted regardless of the specification of a terminal display, thereby allowing users to share, edit and arrange the handwritten input information.

### Technical Solution

In order to solve the above problems, the present invention provides a wire and/or wireless handwriting instant messenger system, in which a position signal of an electronic pen including pen pressure information is transformed into a vector-type handwritten input information, processed as object structure information, and then easily optimized and displayed suitably for the standards of various terminal displays such that users can freely share handwritten data over a wire and/or wireless network regardless of the standards of the terminal displays.

According to the present invention, a system for transmitting handwriting instant messages through a wire and/or wireless network comprises: a handwritten input information generating module for generating a position detection signal based on movement of an electronic pen, transforming the signal into vector-type handwritten input information, and then transmitting the handwritten input information; a transmission terminal receiving the handwritten input information from the handwritten input information generating module and creating handwritten instant message information based on the handwritten input information to transmit the handwritten instant message information to an external network through a wire or wireless network; a server receiving the handwritten instant message information through the wire or wireless network and transmitting the handwritten instant message information to a receiver to provide a handwritten instant message service; and a reception terminal for receiving the handwritten instant message information transmitted through the server.

The handwritten input information generating module includes: an electronic pen module for generating pen pressure information and a position signal including first and second reference signals; and a digital position information generating module for detecting the position signal to transform the position signal into vector-type handwritten input information and processing the pen pressure information.

Further, the electronic pen module comprises: a first reference signal transmitting module for creating a first reference signal provided with one of a radio frequency (RF) signal and an infrared signal; a pen pressure information detecting module for detecting pen pressure applied in handwriting, converting the pen pressure into predetermined information, and transmitting the information with the first reference signal by adding the information to the first reference signal through a modulation process; a second reference signal transmitting module for creating a second reference signal having a propagation speed slower than a propagation speed of the first reference signal; and a power supplying module for supplying power to each module.

The digital position information generating module comprises: a first reference signal receiving module for receiving the first reference signal; at least two second reference signal receiving modules for receiving the second reference signal being spaced apart from each other by a predetermined distance; a data processing module calculating a position of the electronic pen module based on a difference in arriving times of the second reference signals at the at least two second reference signal receiving modules with reference to the arriving time of the first reference signal at the first reference signal receiving module, and then transforming the calculated position into the vector-type handwritten input information; and a terminal interface module used to transmit the handwritten input information to the transmission terminal through a wire or wireless data communication scheme.

Further, the digital position information generating module further comprises a sub-memory module capable of storing the handwritten input information.

Further, the data processing module of the digital position information generating module further comprises a function of converting the pen pressure information transmitted through the first reference signal into a predetermined data formation through a demodulation process.

With detection of the pen pressure using the pen pressure information detecting module, thickness of handwritten tracks or drawings made by using electronic pen can be expressed.

Further, the type of the transmission terminal is not limited, and the transmission terminal includes any one selected from the group consisting of a portable phone, a wireless computer, a PDA, a smart phone, a WiBro terminal, a ground-wave DMB terminal, a satellite DMB terminal, a cable computer, a cable phone, and a digital TV set-top box.

The transmission terminal comprises a peripheral device interface module connected with the handwritten input information generating module through a wire or wireless data communication scheme; a processing module for providing operation functions used to drive the transmission terminal; an application module for selectively driving at least one of a game, an electronic dictionary, an electronic calculator, an electronic note, a handwritten recognition program, a voice recognition program, and MP3 and moving picture reproduction; a terminal operating module for controlling the application module; a display module for displaying handwritten instant message information on a screen; a storage module for storing the handwritten input information; a network interface module for transmitting the handwritten input information to the server through an external network; and a handwritten message processing module cooperating with the server to operate and provide a wire and/or wireless instant messenger service.

The handwritten message processing module comprises: a terminal log-in authenticating module for determining a user having a right to use the wire and/or wireless instant messenger service; a management function module, which is synchronized with the server to allow the user to recognize a state of a conversation partner specified by the user, and process transmitted/received handwritten instant message information in cooperation with the server; and a service function module cooperating with the server to provide various handwriting instant messenger services.

According to an embodiment of the present invention, the terminal log-in authenticating module provides two text boxes to allow the user to input a user identifier (ID) and a password for user registration.

Further, the user inputs the user ID and the password into the text boxes of the terminal log-in authenticating module only when the user uses a handwriting instant messenger service for the first time.

Further, the management function module comprises: a conversation partner- or conversation group-managing module for adding a conversation partner or a conversation group, with which the user make conversation through a handwriting instant messenger, or blocking and deleting a specific conversation partner or a specific conversation group; a personal state information managing module for allowing the user to set information about an access state of the user such that the access state of the user is automatically or optionally delivered to the conversation partner or the conversation group and storing personal log-in information for a handwriting instant messenger service such that the log-in information is automatically input when the user accesses the handwriting instant messenger service; and a file managing module for storing and managing information relating to a handwriting instant messenger.

Further, the personal state information managing module has information about a standard of a display provided in the transmission terminal to provide information for realizing a screen adjustment function when the handwritten input information is displayed on a screen of the transmission terminal.

The service function module comprises: an instant messenger conversation function module cooperating with the terminal log-in authenticating module and the management function module of the server to provide a user interface function which is required for the user to use the handwriting instant messenger service; and a data file authoring function module for providing a user interface function having a form of a memo pad or a notebook such that a handwritten input information file is output or reproduced, or the handwritten input information file is transmitted to the conversation partner or the conversation group such that the conversation partner or the conversation group easily outputs or reproduces the handwritten input information file. The service function module may further comprises a schedule management function module cooperating with the server to allow a user to store information about appointments or memos relating to the user and a group in a terminal of a user by inputting handwritten input information into an input format which represents dates, hours, and minutes in such a manner that the information about the appointments and the memos is shared through a file managing and processing module of the server.

According to an embodiment of the present invention, the schedule management function module allows the user to share the handwritten input information prepared in date, hour and minute units with all users, a specific user, or specific plural users belonging to the group in the cooperation with the server.

According to an embodiment of the present invention, the schedule management function module stores handwritten input information, which is obtained through inputting a schedule on specific time in future in a form of a memo or a note, in at least one of the terminal and the server, and allows the user to recognize the handwritten input information through one of a ringing sound and a message if the specific time arrives.

The server comprises: a gateway module cooperating with a wireless or wire data network to manage a connection state between the transmission and reception terminals and the server and to process transmission and reception commands for wire and/or wireless handwriting instant messenger data between specific transmission and reception terminals; a main server system for managing an access approval for a subscriber and storing and managing information of a user or a group of the user while transforming an image and managing a handwritten message data file; and a database module.

According to an embodiment of the present invention, the main server system of the server may additionally perform billing management.

Further, the main server system comprises: an access authentication managing module for determining a subscriber authentication state to manage the access approval for the subscriber in cooperation with the terminal log-in authenticating module of the terminal; a user and group managing module enabling the user and the group to share an access state of an authenticated subscriber and access states of other users belonging to the group, and managing creation of a new group and deletion of the group; a message processing module for sequentially processing message transmission/reception between authenticated users; and a file managing and processing module for storing and processing a file created through handwritten message communication between users.

The main server system further comprises at least one of: an image transforming module for transforming handwritten input information into an image file for a user who is not joined to the wire and/or wireless handwriting instant messenger service; and a billing managing module for managing details of billing caused by the wire and/or wireless handwriting instant messenger service. In this case, the format of the image file may comprise JPG, BMP, etc., and is not limited thereto.

The file managing and processing module comprises functions of: continuously storing handwritten input information within a capacity of a storage space previously assigned to a user in a reception side; automatically deleting the handwritten input information after a predetermined period lapses; setting options of the storage function and the deletion function; and allocating randomly assigned information share storage for plural users used for file sharing between users by using some portions of storage capacity, which is assigned to the users according to demand of the users in transmission and reception sides, within the capacity of the storage capacity.

The type of the reception terminal is not limited. For example, the reception terminal includes any one selected from the group consisting of a portable phone, a wireless computer, a PDA, a smart phone, a WiBro terminal, a ground-wave DMB terminal, a satellite DMB terminal, a cable computer, a cable phone, and a digital TV settop box.

The reception terminal comprises: a peripheral device interface module for receiving the handwritten input information to make communication with an external output device through one of wire and wireless communication schemes; a processing module for providing an operation function used to drive the reception terminal; an application module for selectively operating at least one of a game function using the electronic pen, an electronic dictionary employing a handwriting input scheme, an electronic calculator employing a handwriting input scheme, an electronic note employing a handwriting input scheme, a handwritten recognition program, a voice recognition program, and an MP3 and moving picture reproduction function; a terminal operating module for controlling the application module; a display module for receiving handwritten instant messenger information from the transmission terminal through the server and displaying the handwritten instant messenger information suitably for a screen; a storage module for storing the handwritten input information as a data file having a predetermined format; a network interface module used to receive the handwritten input information through a network employing one of wire and wireless schemes; and a handwritten message processing module cooperating with the server to provide the wire and/or wireless handwriting instant messenger service.

The handwritten message processing module comprises: a terminal log-in authenticating module for determining a user having a right to use the wire and/or wireless instant messenger service; a management function module, which is synchronized with the server to allow the user to recognize a state of a conversation partner specified by the user, and process transmitted/received handwritten instant message information in cooperation with the server; and a service function module cooperating with the server to provide various handwriting instant messenger services.

Preferably, the transmission and reception terminals may have a same structure and function and can be driven in one terminal equipment.

Meanwhile, method for providing a wire and/or wireless handwriting instant messenger service, comprises the steps of:

(1) creating structure information about a unit track object diagram for a track handwritten by using an electronic pen; and
(2) grouping the unit tract object diagram to create structure information of a track diagram group.

In this case, step (1) comprises the steps of: (1) inputting contents through a handwriting scheme by using the electronic pen; (2) creating a first reference signal using one of a radio frequency and an infrared ray and a second reference signal having a propagation speed slower than a propagation speed of the first reference signal, as position signals when the contents are input by using the electronic pen; (3) creating coordinate information by calculating the coordinate information about a handwritten track based on arriving time of the second reference signal to at least two reference signal receiving modules after the first reference signal has arrived at a first reference signal receiving module; (4) creating information about a minimum bounding box enclosing a whole range of a unit tract object diagram corresponding to the created coordinate information; and (5) creating information about initial track transformation of the unit tract object diagram provided through an Affine matrix equation having a 3×3 square matrix structure.

In this case, step (2) comprises the steps of: (1) grouping the structure information about a plurality of the unit tract object diagrams to create the structure information about the track diagram group; and (2) creating the structure information about the track diagram group by inserting initial track transformation information of the tack diagram group and information about the minimum bounding box, which includes number information of object diagram groups and a range of unit track object diagram group, into the structure information about the track diagram group.

Preferably, step (2) further comprises a step of detecting pen pressure applied by the electronic pen, transforming the pen pressure into predetermined pen pressure information, and then carrying the pen pressure information with the first reference signal through a modulation scheme.

Preferably, step (1) further comprises a step of inputting image color information for the unit track object diagram.

### ADVANTAGEOUS EFFECTS

The handwriting wireless and/or wire instant messenger system and the method for controlling the same according to the embodiment have the following effects.

First, the present invention relates to a technology used to effectively perform a handwriting instant messenger function between wire/wireless terminals having various display specifications and being currently driven under a typical wire and/or wireless network environment. According to the present invention, intuitive and user-friendly handwriting message communication using drawings or numerical formulas can be expanded to a wireless environment as well as a wire environment, instead of an inconvenient push-button key pad input scheme in which complicated key input must be performed several times, so that a user can more conveniently use a wire and/or wireless communication service through a user-friendly handwriting type user interface. Accordingly, it is expected that a wire and/or wireless communication service can be activated and technical development can be achieved.

Second, a position signal of an electronic pen is transformed into vector-type handwritten track information to form object structure information to which an Affine transformation matrix algorithm is applied. Accordingly, original data of a handwritten track having a vector-type storage structure can be transformed and edited only by transforming information about a transformation matrix without causing damage to the original data when performing editing functions, such as enlargement and reduction, and partial or whole extraction, deletion, and modification. The original data of the initial handwritten track information created by using the electronic pen are preserved without causing damage to the information even if track transformation and image shape transformation are repeated several times. Accordingly, in handwriting instant messenger communication between various terminals having various terminal display standards under a wire/wireless network environment, an image optimized for each terminal can be easily expressed without causing damage to the original track information by changing only the value of an Affine transformation matrix according to each display environment. Further, enlargement, reduction, scrolling, and landscape/portrait functions can be expressed by transforming coordinates only when the actual track data are preserved and displayed on a screen. Even in various image transformation such as enlargement, reduction, movement, and rotation, only a transformation matrix value is simply transformed without transforming the original data, thereby minimizing the inefficiency of individually operating and transforming each coordinate value according to image transformation and conveniently performing image transformation and restoration.

Third, object structure information to which a bounding box algorithm having information about the setting of a track transformation area is formed by using the position signal of the electronic pen, so that the optimum image can be easily expressed matching with standards for various screen images on which handwritten input information is displayed.

Fourth, in a wire and/or wireless handwriting instant messenger system according to the present invention, a transmitter can easily detect the counterpart who frequently makes communication with the transmitter in ordinary times through simple manipulation without performing a complicated input process such as the input of a phone number, or an e-mail address for calling the counterpart or transmitting the message to the counterpart. In addition, if the transmitter cannot instantly transmit the message, the transmitter can transmit the message to the counterpart through various message transmission tools such as an e-mail or a fax.

Fifth, transmitted handwritten input information data can be freely stored and managed for a predetermined period or within the capacity of an allocated storage space that are set through a server. In particular, randomly assigned information share storage function is provided to share a predetermined storage space allocated to a transmitter, a receiver and each receiving group, thereby improving user convenience.

Sixth, in the case of a schedule managing function, a user inputs important information such as the schedule or the memo of the user through an easy handwriting scheme instead of an inconvenient key pad input scheme, so that the user can check the schedule and the memo by reproducing the schedule and the memo in the form of the handwritten image. In particular, the whole schedule or the announcement of a user group, such as a company or a project team of the user, can be shared through the randomly assigned information share storage function, by which the storage capacity allocated to the user or the user group is randomly shared, thereby improving user convenience.

### DESCRIPTION OF DRAWINGS

FIG. 1 is a block diagram schematically showing a conventional MMS;

FIG. 2 is a block diagram showing the structure of a wire and/or wireless instant messenger system which includes a mobile terminal according to the present invention;

FIG. 3 is a block diagram showing a detailed structure of the first handwritten input information generator;

FIG. 4 is a view showing a transmission terminal and the first handwritten input formation generator according to an embodiment of the present invention, in which a portable phone is used as an example of the transmission terminal;

FIG. 5 is a view showing an electronic pen having the shape of a ballpoint pen according to an embodiment of the present invention;

FIGS. 6 and 7 are views showing a scheme of recognizing coordinates based on a position signal of an electronic pen according to the present invention;

FIG. 8 is a block diagram showing the detailed structure of a handwritten message processing module according to the present invention;

FIG. 9 is a flowchart showing the creation of handwritten track information for the transmission of a handwriting instant messenger according to the present invention;

FIG. 10 is a view showing the structure of a unit handwritten track diagram object on a memory according to the present invention;

FIG. 11 is a view showing the structure of a handwritten track diagram group on a memory according to the present invention;

FIG. 12 is a view showing an algorithm for the image transformation of a handwritten track according to the present invention;

FIG. 13 are views showing a screen size and screen resolution in enlargement/reduction for a handwritten image according to the present invention;

FIG. 14 is a block diagram showing the structure of a wire and/or wireless handwriting instant messenger system of transmitting handwritten track information according to the present invention;

FIG. 15 is a block diagram showing the structure of a server of the wire and/or wireless handwriting instant messenger system; and

FIG. 16 shows screen images of a portable appliance when writing a message through a wire and/or wireless handwriting instant messenger system according to the present invention.

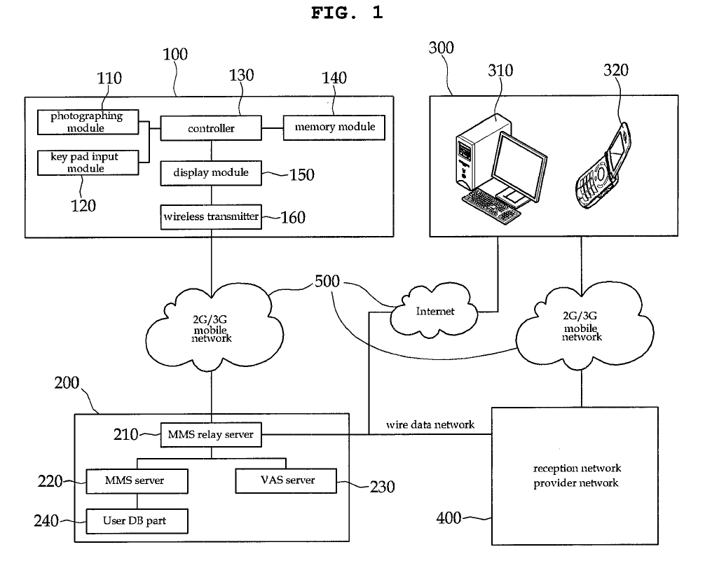

### DESCRIPTION OF SYMBOLS OF THE MAIN PARTS IN THE DRAWINGS

1000, 9000: first and second handwritten input information generators
1100: a digital position information generator 1100,
1110: terminal interface module
1120: data processing module
1130: sub-memory module
1140: first reference signal receiving module
1150, 1150a, 1150b: reference signal receiving module
1200: electronic pen
1210: pen pressure information detecting module
1220: first reference signal transmitting module
1230: second reference signal transmitting module
1240: power supplying module
2000: transmission terminal
2100, 9100: wireless transmission terminal
3000: wireless data network
3100: wire data network
4000, 9400: first and second servers.
4100, 9410: first and second gateway servers
4200, 9420: first and second main server systems
4210, 9421: first and second access authentication managing modules
4220, 9422: first and second user and group managing modules
4230, 9423: first and second message processing modules
4240, 9424: first and second image transforming modules
4250, 9425: first and second file managing and processing modules
4260, 9426: first and second billing managing modules
4270, 9427: first and second databases
5000: reception terminal
5100, 9500: first and second wireless transmission terminals
5110, 5210: third and fourth application modules
5120, 5220: third and fourth handwritten message processing modules
5130, 5230: third and fourth terminal operating modules
5140, 5240: third and fourth network interface modules
5150, 5250: third and fourth storage modules
5160, 5260: third and fourth display modules
5170, 5270: third and fourth peripheral device interface modules
5180, 5280: third and fourth peripheral device interface modules
5200, 9600: first and second wire reception terminals.
6100: first object classifying module
6200: image color module 6300: thickness information module
6400: track point calculating module 6500: track point coordinate module
6600: editing module 6700: reediting module
6800: Affine matrix applying module
6900: track group coloring module
7100: second object classifying module
7200: track group coloring module
7300: diagram number defining module
7400: object group data providing module
8100: coordinate transforming module
8110: coordinate transformation Affine matrix module
8120: inverse matrix applying module 8121: diagram object
8122: diagram grouping 9300: wire and/or wireless network

### BEST MODE

### Mode for Invention

Hereinafter, the present invention will be described in detail with reference to accompanying drawings.

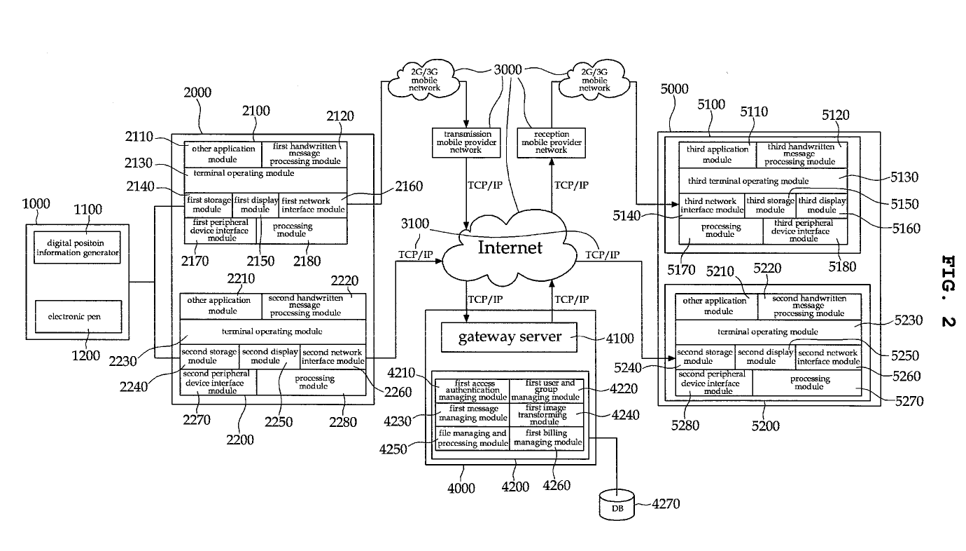

FIG. 2 is a block diagram showing the structure of a wire and/or wireless handwriting instant messenger system. The wire and/or wireless handwriting instant messenger system has a structure in which handwritten input information can be transmitted between various kinds of terminals through a wire and/or wireless handwriting instant messenger server. In addition, the wire and/or wireless handwriting instant messenger system can also transmit text data.

The wire and/or wireless handwriting instant messenger system includes a first handwritten input information generator 1000, a transmission terminal 2000, a first server 4000, and a reception terminal 5000. The first handwritten input information generator 1000 generates a signal based on the moving route of an electronic pen and pen pressure, converts the signal into vector-type handwritten input information, and transmits the handwritten input information to a wire/wireless transmission terminal. The transmission terminal 2000 receives the handwritten input information, converts the handwritten input information into information having a predetermined format according to the state of each terminal, displays, stores, or edits the converted information, and then transmits the converted information through a wireless data network 3000 or a wire data network 3100. The first server 4000 stores and processes the information transmitted from the transmission terminal 2000 in the form of handwritten input information or a text. The reception terminal 5000 receives, displays, edits, stores and manages the information stored in the first server 4000.

Regarding the detailed structure of the wire and/or wireless handwriting instant messenger system, the first handwritten input information generator 1000 includes a digital position information generator 1100, which determines a position signal of a handwritten track and pen pressure detection information input from a user through an electronic pen to generate vector-type handwritten input information, and an electronic pen 1200, which error-freely generates an exact position signal and pen pressure detection information when a user creates track information through a handwriting operation. In addition, the transmission terminal 2000 and the reception terminal 5000 include a first wireless or wire transmission terminal 2100 or 2200 and a first wireless or wire reception terminal 5100 or 5200, respectively, to form handwritten input information such that the handwritten input information can be edited, stored, and managed in the first wire or wireless transmission terminal 2100 or 2200 and the first wire or wireless reception terminals 5100 or 5200.

Hereinafter, the functions of the components will be described in detail.

The first wireless transmission terminal 2100 cooperates with the first server 4000 to perform log-in authentication of determining if a log-in user is an authenticated user, the management for conversation partners and their groups, the management for personal information and files, and schedule management through a first handwritten message processing module 2120. To this end, the first wireless transmission terminal 2100 includes a first network interface module 2160, which displays handwritten input information generated from the first handwritten input information generator 1000 on a first display module 2150, edits the handwritten input information, and stores the handwritten input information in a first storage module 2140 to transmit the handwritten input information to the first server 4000 through the wireless data network 3000, and a first peripheral device interface module 2170, which makes data communication between the first handwritten input information generator 1000 and the transmission terminal 2000. In this case, the first peripheral device interface module 2170 may employ wire schemes or wireless schemes such as the Bluetooth.

The first wire transmission terminal 2200 includes a second network interface module 2260, which allows the first wire transmission terminal 2200 to recognize handwritten track information generated from the first handwritten input information generator 1000, display the handwritten track information on a second display module 2250, edit the handwritten track information for user convenience, and store the handwritten track information on a second storage module 2240 to transmit the handwritten track information to the first server 4000 in cooperation with the wire data network 3100 (e.g., ultra high speed network, etc.), and a second peripheral device interface module 2270, which makes communication between the first handwritten input information generator 1000 and the first wire transmission terminal 2200. The second peripheral device interface module 2270 may employ wire schemes or wireless schemes such as the Bluetooth.

The first server 4000 performs a management function such that information provided from the transmission terminal 2000 is received therein and suitably transmitted to the reception terminal 5000 through the wireless data network 3000 or the wire data network 3100 internetworking with a wireless network and a wire network such as an ultra high-speed Internet or a digital TV network.

The reception terminal 5000 includes the first wireless reception terminal 5100, which receives information transmitted from the transmission terminal 2000 through the server 4000 in a wire and/or wireless network including the wireless data network 3000 and the wire data network 3100 such as the ultra-speed Internet or a digital TV network, displays the information on a display device, edits, stores, and manages the information, and receives input information through the radio data network 3000 such as a 2G or 3G radio network in the wire and/or wireless network, and the first wire reception terminal 5200, which receives information generated from the transmission terminal 2000 through the server 4000 in the wire data network 3100 such as the ultra-high speed Internet, displays the information on the display device, edits, stores, and manages the information similarly to the first wireless reception terminal 5100.

Hereinafter, the first wireless reception terminal 5100 will be described in the same manner as that of the transmission terminal 2000. The first wireless reception terminal 5100 includes a third peripheral device interface module 5270, which suitably displays information about a handwritten track that has been generated from the first handwritten input information generator 1000 on a third display module 5160 of the first wireless reception terminal 5100 through a third network interface module 5140 cooperating with the wireless data network 3000, edits the information for user convenience or stores the information in a third storage module 5150, and makes communication with an external appliance such as an external memory. The third peripheral device interface module 5270 may employ a wire scheme or a wireless scheme such as Bluetooth.

Similarly to the first wireless reception terminal 5100, the first wire reception terminal 5200 includes a fourth peripheral device interface module 5180 that suitably displays information about a handwritten track, which has been generated from the first handwritten input information generator 1000, on a fourth display module 5260 of the first wire reception terminal 5200 through a fourth network interface module 5240 cooperating with the wire data network 3100, edits the information for user convenience or stores the information in a fourth storage module 5250, and makes communication with an external appliance such as an external memory. The fourth peripheral device interface module 5270 may employ a wire scheme or a wireless scheme such as Bluetooth.

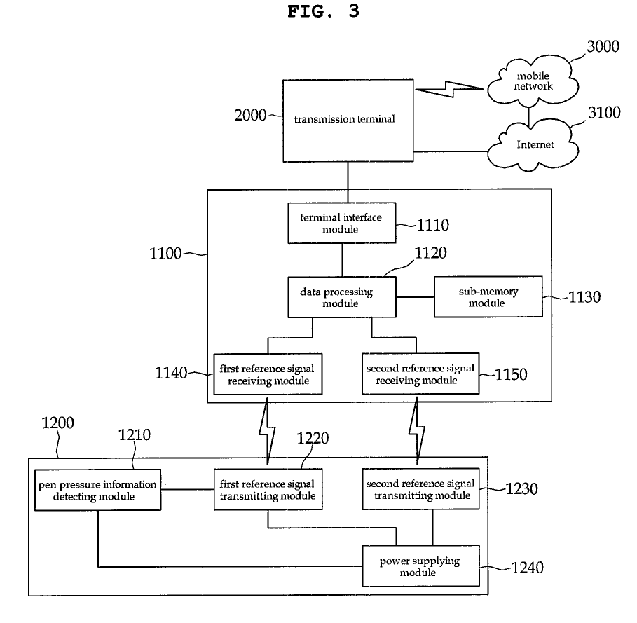

FIG. 3 is a block diagram showing a detailed structure of the first handwritten input information generator 1000. The first handwritten input information generator 1000 includes the electronic pen 1200 and the digital position information generator 1100, in which the electronic pen 1200 generates a position signal of a handwritten track and pen pressure information, and the digital position information generator 1100 converts the position signal and the pen pressure information into a handwritten input information to transmit the handwritten input information to the transmission terminal 2000, such that the handwritten input information can be displayed, edited, or stored in the transmission terminal 2000.

Hereinafter, the operational procedure of the handwritten input information generator 1000 having the above structure will be described.

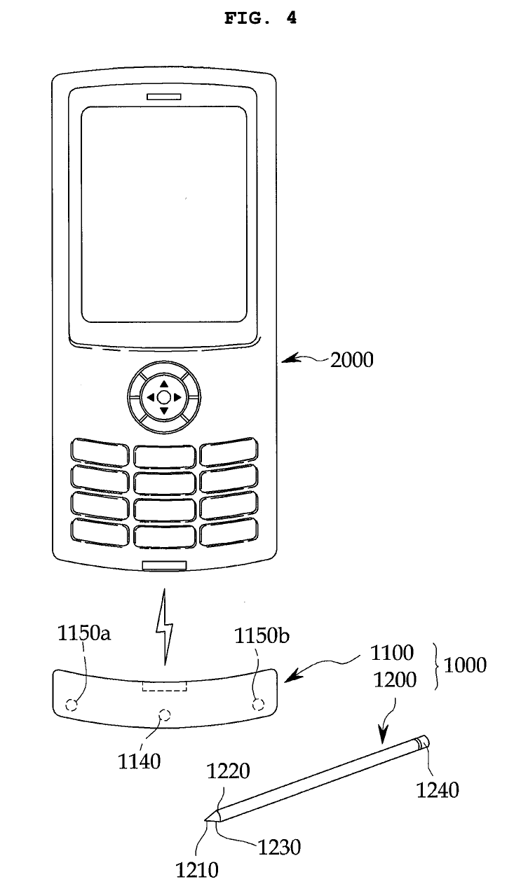

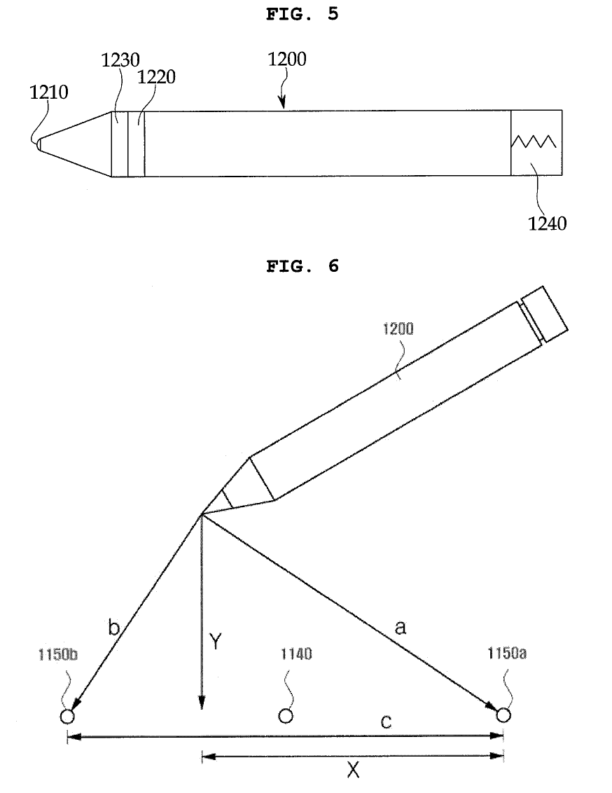

Referring to FIGS. 4 and 5, the electronic pen 1200 includes a first reference signal transmitting module 1220, a second reference signal transmitting module 1230, a pen pressure information detecting module 1210, and a power supplying module 3240. The electronic pen 1200 may have various shapes. For example, as shown in FIG. 5, the electronic pen 1200 may have the shape of a pencil, a ballpoint pen, or a fountain pen.

The first reference signal transmitting module 1220 transmits a first reference signal by receiving power from the power supplying module 1240.

The first reference signal generated from the first reference signal transmitting module 1220 is a synchronization signal used to recognize the position of the electronic pen 1200, and may be provided in various types. Preferably, the first reference signal is faster than the second reference signal. This is because a data processing module 1120 recognizes the position of the electronic pen 1200 by using a difference in arriving time between the first and second reference signals. Accordingly, the first reference signal must arrive in the digital position information generator 1100 faster than the second reference signal. For example, if the second reference signal is an ultrasonic signal, the first reference signal may be an infrared signal or a radio frequency (RF) signal having a propagation speed faster than that of the second reference signal.

In addition, the pen pressure information detecting module 1210 detects the pen pressure exerted on the electronic pen in handwriting or other manipulation of a user through the electronic pen, converts a predetermined signal obtained from the detection into predetermined pen pressure information, modulates the pen pressure information, and then carries the pen pressure information to the first reference signal receiving module 1220, so that the pen pressure information is processed in the data processing module 1120 through a first reference signal receiving module 1140 of the digital position information generator 1100. In this case, the pen pressure information detecting module 1210 detects the pen pressure, thereby expressing the thickness the thickness of a handwritten track or an image generated by the electronic pen.

The second reference signal transmitting module 1230 transmits the second reference signal by receiving power from the power supplying module 1240.

Preferably, at least one second reference signal transmitting module 1230 is provided. A scheme of recognizing the position of the electronic pen 1200 by using the first and second reference signals will be described later.

Although the type of the second reference signal is restricted, preferably, the second reference signal is provided with a propagation speed slower than that of the first reference signal as described above. For example, if the first reference signal is provided as an infrared signal or an RF signal, the second reference signal may be provided as an ultrasonic signal.

The digital position information generator 1100 includes the first reference signal receiving module 1140, at least two second reference signal receiving modules 1150, the data processing module 1120, and a terminal interface module 1110. The first reference signal receiving module 1140 receives the first reference signal generated from the electronic pen 1200. The second reference signal receiving module 1150 receives the second reference signal. The data processing module 1120 determines the position of the electronic pen 1200 based on the difference between reception time points of the first reference signal and at least two second reference signals received from the first reference signal receiving module 1140 and at least two second reference signal receiving modules 1150 (1150 (a) and 1150 (b)) to obtain vector-type position information, converts the position information into information having a predetermined data format, that is, digital position information in order to transmit the position information to the transmission terminal 2000 based on vector information and pen pressure information. The terminal interface module 1110 is used to transmit the digital position information to the transmission terminal 2000.

Preferably, the digital position information generator 1110 includes a sub-memory module 1130 capable of storing the digital position information. A wire access scheme using a communication cable and a wireless access scheme such as Bluetooth using a radio frequency (RF) may be employed to make data communication between the digital position information generator 1100 and the transmission terminal 2000.

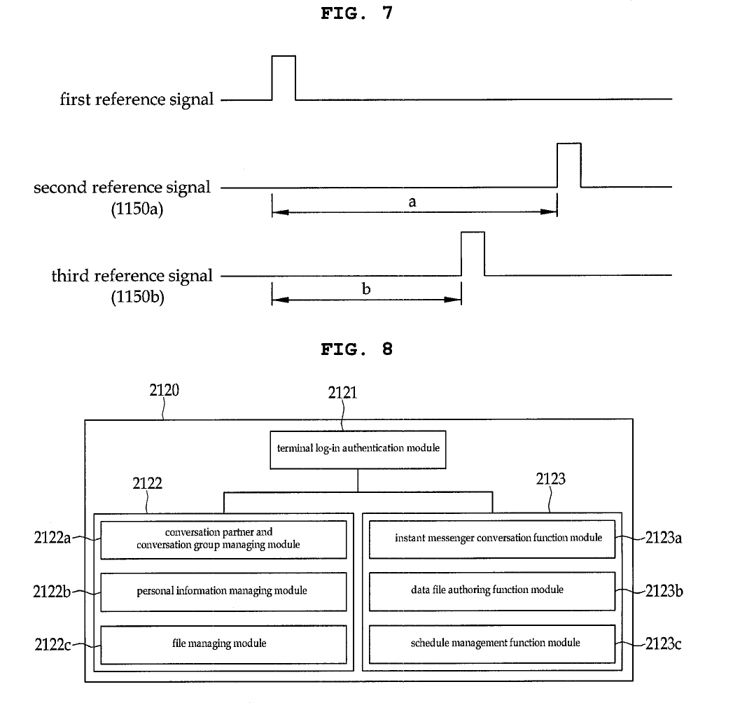

FIGS. 6 and 7 are views showing a scheme of recognizing coordinates based on a position signal of an electronic pen according to the present invention. As shown in FIGS. 3 and 4, the data processing module 1120 tracks the position of the same electronic pen based on signals input through the first reference signal receiving module 1140 for receiving the first reference signal and at least two second reference signal receiving modules 1150a and 1150b for receiving the second reference signals. In this case, under an assumption that the speed of light approaches infinity, since a receiving module (the first reference signal receiving module) detects the movement of an electronic pen as soon as the electronic pen moves, an infrared (IR) signal or an RF signal that is a kind of an electromagnetic wave may be used as a reference signal for distance measurement.

On the assumption that the distance between the second reference signal receiving modules 1150a and 1150b arranged in a line is “c”, the distance to the electronic pen 1200 from the second reference signal receiving module 1150a at the right side is “a” the distance to the second electronic signal receiving module 1150b at the left side from the electronic pen 1200 is “b”, the horizontal distance to the electronic pen 1200 from the second reference signal receiving module 1150a at the right side is “x”, and the vertical distance to the electronic pen 1200 from the reference signal receiving modules 1140, 1150a, and 1150b is “y”, the following equations are formed through the Pythagorean theorem.

a²=x²+y² [Equation 1]

b²=(c−x)²+y² [Equation 2]

In this case, the value of “a” is changed according to the type of the second reference signal. For example, if the second reference signal is an ultrasonic wave signal, the value of “a” may be calculated by multiplying the speed of the ultrasonic wave signal (which has been previously obtained) by a difference between arriving time of the first reference signal and arriving time of the ultrasonic wave signal that arrives at the second reference signal transmitting module 1150a in the right side.

The value of “b” may be calculated by multiplying the speed of the ultrasonic wave signal by a difference between arriving time of the first reference signal and arriving time of the ultrasonic wave signal that arrives at the second reference signal receiving module 1150b in the left side.

Accordingly, in Equations 1 and 2, since the values of “a”, “b” and “c” are known values, the values of “x” and “y” can be found if the values of “a”, “b” and “c” are substituted to Equations 1 and 2 in order to solve the simultaneous equations.

The data processing module 1120 simultaneously calculates the values of “x” and “y” as described above to track the position of the electronic pen 1200 and convert the values of “x” and “y” into handwritten input information.

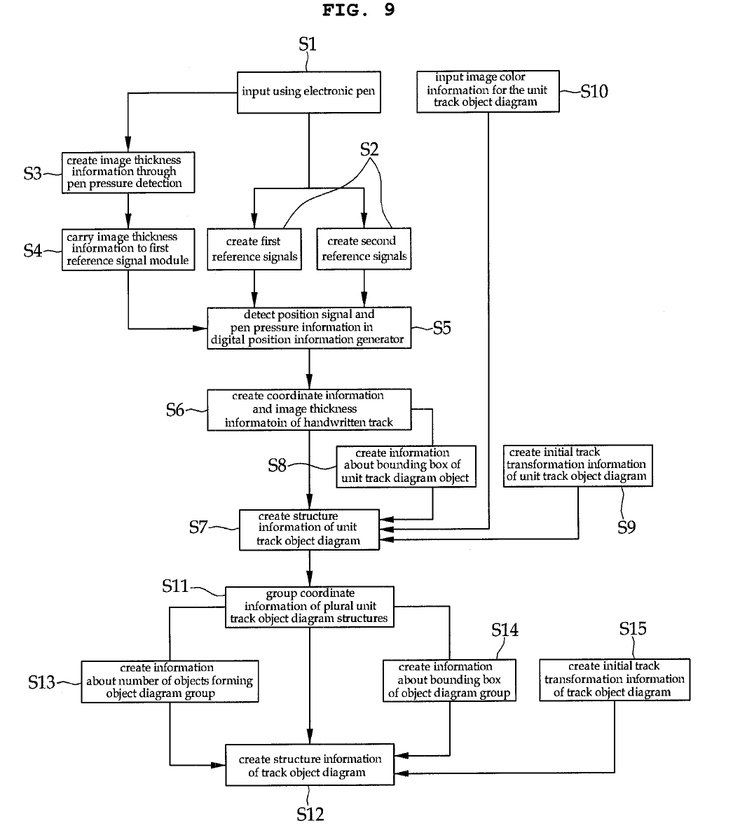

FIG. 8 is a block diagram showing the detailed structure of the handwritten message processing module adjustable for the present invention. The handwritten message processing module 2120 is a set of various kinds of programs used to drive applications for a handwritten message on a terminal, and is identically employed in the transmission and reception terminals 2000 and 5000. The first to fourth handwritten message processing modules 2120, 2220, 5120, and 5220 have substantially same functions in the first wireless transmission and reception terminals 2100 and 5100 and the first wire transmission and reception terminals 2200 and 5200. However, some functions of the first and third handwritten message processing modules 2120 and 5120 relating to input and modification are omitted in the first wireless transmission and reception terminals 2100 and 5100 because there is more restriction in a display size of a portable terminal as compared with that of the second and fourth handwritten message processing modules 2220 and 5220 of the first wire transmission and reception terminals 2200 and 5200. Details thereof will be given in the following description. The first handwritten message processing module 2120 includes a terminal log-in authentication module 2121, a management function module 2122, and a service function module 2123, and the detailed functions of the above components will be described below.

The terminal log-in authentication module 2121 determines if a log-in user is authenticated when the user logs in so as to use a handwriting instant message service adaptable for the present invention, and provides two text boxes enabling the user to input a user ID and a password.

The terminal log-in authentication module 2121 performs a main function of allowing a user to input the user ID into an user ID input text box only in initial use of a handwriting instant message and automatically storing the user ID in a personal information managing module 2122b, so that the terminal log-in authentication module 2121 automatically recognizes the user ID in the following log-in process, thereby removing inconvenience of the user who inputs the user ID whenever he/she attempts to log-in. If necessary, the user ID may be forcefully modified. When a user ID is input or the user ID is automatically determined, a password is input, and then a log-in button is pressed, the state information about user access to the handwriting instant message service is transmitted to the first server 4000, so that the user may have a conversation with another user joined to the handwriting instant messenger service in real time through the handwriting instant messenger. In addition, when the first server 4000 provides version-up information to the first transmission and reception terminals 2100 and 5100, the terminal log-in authentication module 2121 automatically accesses a corresponding service provider to download an upgrade program. If information about “suceess” or “failure” relating to message or file transmission is received from the first server 4000, the terminal log-in authentication module 2121 responds to the first server 4000 by using a message.

The management function module 2122 includes a conversation partner and conversation group managing module 2122a, a personal information managing module 2122b, and a file managing module 2122c. The conversation partner and conversation group managing module 2122a adds a conversation partner or a conversation group for the handwriting instant messenger service, moves a conversation partner into another group, and blocks and deletes a specific conversation partner. In detail, the conversation partner and conversation group managing module 2122a adds a conversation partner who has subscribed to the handwriting instant messenger service based on the sever 4000 and a first group managing module 4220, moves the conversation partner into another group, to which a specific conversation partner belongs, and blocks or deletes a specific conversation partner if necessary. The personal information managing module 2122b maintains the latest call and connection information (e.g., user ID, user name, nick name, password, e-mail, fax number, phone number, etc.) of users belonging to all user groups in synchronization with the server 4000 when the handwriting instant messenger service is used. In addition, the personal information managing module 2122b stores initially input log-in information to enable automatic log-in when the user accesses the handwriting instant messenger service through a terminal of a user. In the case of a program for a portable terminal, only essential items such as the nick name, password, e-mail address, and fax number may be modified by taking the difficulty in the manipulation of the portable terminal into consideration. In the case of a terminal such as a personal computer (PC) allowing the user to easily input information, various management such as input and modification of personal information can be achieved.

The service function module 2123 includes an instant messenger conversation function module 2123a, a data file authoring function module 2123b, and a schedule management function module 2123c, and the functions of the components will be described below in detail.

The instant messenger conversation function module 2123a allows a user to log in and then select a conversation partner or a conversation group on the screen image for the handwriting instant messenger service to have conversation with the selected conversation partner or the conversation group in real time. In this case, the real-time conversation based on the wire and/or wireless handwriting instant messenger service is basically achieved through a handwriting scheme, and it is natural that existing text-based conversation should be possible. Regarding the detailed function of the instant messenger conversation function module 2123a, if a user selects a conversation group and presses a selection button, the connection states information about all conversation partners belonging to the conversation group are requested, and the server 4000 transmits present connection state information of the conversation partners to a corresponding terminal to display the information on a screen. If the user selects a conversation partner and selects a conversation function in a menu, a conversation window is displayed on a screen, and a handwritten message generated by the first handwritten input information generator 1000 is input into a transmission input box located in the lower portion of the conversation window, or a text is input through a key board or a key pad of a user terminal, thereby enabling communication between the user and the conversation partner. However, if a conversation group has been selected in order to have a conversation, the conversation function cannot be selected, but only a handwritten input information file generated from the data file authoring function module 2123b can be simultaneously transmitted to the conversation group. In addition to the real-time instant messenger conversation function, the data file authoring function module 2123b generates a handwritten input information file through the handwritten input information generator 1000 by using a memo or records handwritten on a notebook to store the file in the first and second storage modules 2140 and 2240 of the transmission terminal or transmit the file to the single or plural reception terminals 5100 and 5200 through the first and second network interface modules 2160 and 2260 and the first server 4000. In detail, the data file authoring function module 2123b selects a single conversation partner from a conversation group to transmit the handwritten input information file or selects a plurality of conversation partners from a window for the setting of handwritten data file transmission instead of a specific conversation partner to simultaneously transmit the handwritten data file to the plural conversation partners. In addition, the data file authoring function module 2123b may directly transmit the handwritten data file to the reception terminal based on the information about the connection state of a conversation partner, or transmit the handwritten data file through an E-mail or a Fax.

In particular, the handwritten data file, which has been transmitted to the server 4000 through the first and second network interface modules 2160 and 2260, may be continuously stored within the capacity of storage spaces assigned to users in the transmission and reception sides by a first file managing and processing module 4250 of the server 4000, or may be automatically and integrally deleted from the storage space after a predetermined period elapses. The data file authoring function module 2123b can appoint separated storage spaces for file sharing between the users by sparing portions of the assigned storage spaces within the capacity of the assigned storage spaces to the users according to users demand.

The schedule management function module 2123c manages personal schedule management of a user, or allows the user to share the schedule and the information about a specific group to which the user belongs by receiving various schedule information (appointment, important memo) or memorial days of the group. The schedule information may be input according to dates, hours, and minutes, and be recorded by creating handwritten information of a user and inserting the handwritten information into a schedule information input blank. In particular, a user of a mobile terminal conveniently inputs the handwritten input information into the schedule information input blank according to dates, hours, and minutes instead of inconveniently inputting text-based schedule information through a key pad.

Especially, in the case of group schedule management, users belonging to groups can share the whole schedule and information of the groups, so that the user belonging to plural groups such as a reunion group and a company group can integrally manage the schedules of the plural groups. In addition, the schedule management function module 2123c allows a user to recognize schedule information previously input as a handwriting data file through a ringing sound or message transmission and to frequently check a whole schedule according to dates, hours, and minutes, so that user convenience may be improved. The schedule management function module 2123c allows a user to previously recognize the schedule of a corresponding date and hour and a future schedule, and stores information such as a memo or a note created as the handwritten input information in the third and fourth storage modules 5150 and 5250 of the first wireless and wire reception terminals 5100 or 5200, or the first file managing and processing module 4250 of the first server 4000 to reproduce, determine, or output the memo or the note stored as the handwritten input information a specific time.

In particular, handwritten input information, such as conference records, to be shared in a user group is stored in the fist file managing and processing module 4250 of the first server 4000, and a specific storage space for the handwritten input information is spared such that the user group can share the handwritten input information. In this case, if a new handwritten input information file is created in the server 4000 and if each user belonging to the user group accesses a handwriting instant messenger service network, the user makes communication with the server 4000 to automatically download the new handwritten input information file and synchronize with the server 4000.

FIG. 9 is a flowchart showing the creation of handwritten track information used for a transmission function of a handwriting instant messenger according to the present invention, and details thereof will be described below.

If a user handwrites texts and diagrams by using an electronic pen (step S1), the first and second reference signal transmitting modules of the electronic pen generate reference signals used for position detection (step S2). In this case, the degree of the pen pressure applied in the handwriting is detected to create pen pressure information (step S3). The crated pen pressure information is modulated and then carried to the first reference signal transmitting module 1220 (step S4). Thereafter, the pen pressure information is transmitted to the first reference signal receiving module 1140 and then processed in the data processing module. The first and second reference signals are detected by the first and second reference signal receiving modules 1140 and 1150 of the digital position information generator 1100 (step S5). Then, the data processing module 1120 of the digital position information generator creates vector-type coordinate information and image thickness information corresponding to each coordinate of the handwritten tack through the above operational procedure (step S6), and structure information about a unit track object diagram for the handwritten track (step S7). The structure information about the unit track object diagram includes information about the minimum bounding box including a whole range of a unit handwriting tack and initial track transformation information that is a basic value of a transformation matrix used to process track transformation information of the unit tract object diagram (steps S8 and S9). The structure information about the unit track object diagram includes image color information of the unit tack object diagram in order to define an image color of the unit track object diagram for user convenience (step S10). As a user continuously carries out a handwriting operation, the structure information about plural unit tack object diagrams is created, and plural unit tack object diagrams are automatically grouped (step S11). In order to create structure information of a unit diagram group (step S12), the number information of the unit track object diagram group (step S13), information about the minimum bounding box including the whole unit track object diagram group and initial track transformation information which is a basic value of a transformation matrix used to process track transformation information for the track diagram group are included in the structure information of the track diagram group (step S15).

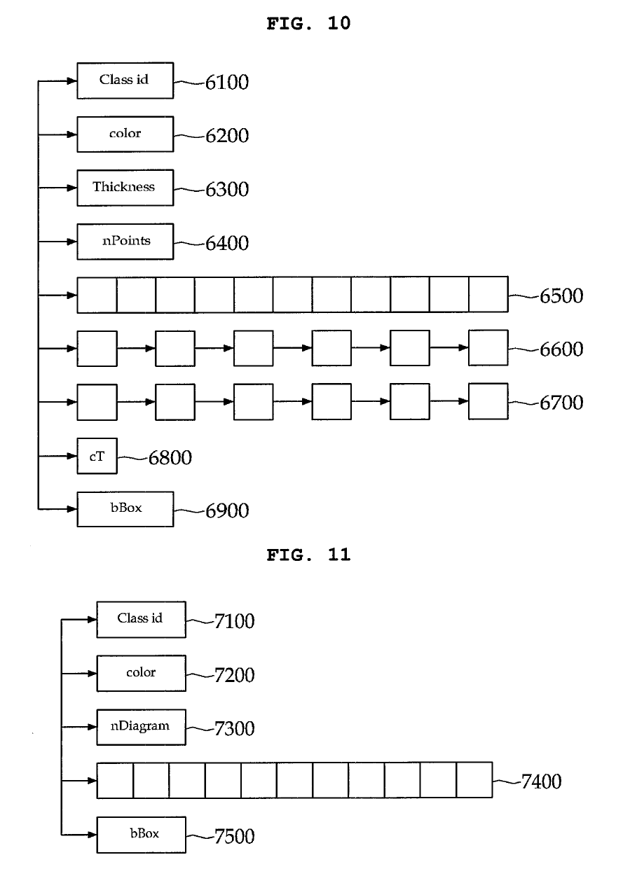

FIG. 10 is a view showing the structure of a unit handwritten track diagram object on a memory according to the present invention, and detailed functions are shown in following table 1.

TABLE 1
Function of Unit Handwritten track Diagram Object on Memory

| | |
|---|---|
| Class ID | “Class ID” represents the type of a diagram. A unit |
| (6100) | track object is distinguished from a diagram group. |
| | Since the present unit track object diagram relates |
| | to an object type, bit values representing the object |
| | type are stored in “Class ID” |
| Color | “Color” represents the color of a track, and has an |
| (6200) | R, G, and B (red, green, and blue) value. |
| Thickness | “Thickness” represents thickness information about a |
| (6300) | unit track object based on pen pressure information |
| | created by an electronic pen. |
| nPoints | “Points” represents the number of points forming a |
| (6400) | unit track. |
| Points | “Points” represents the array for vector-type |
| (6500) | coordinates of points forming a unit track, and has |
| | information of the unit track that has been created |
| | in the first stage without modification. Even in |
| | edition operations such as enlargement, reduction, |
| | and movement, the value of “Points” is not changed. |
| Undo | “Undo History” stores edited information such that an |
| History | undo function can be performed. An edition function |
| (6600) | for an object is a color change and and a diagram |
| | transformation. In the case of the color changing |
| | function, RGB values before color change are stored |
| | in “Undo History” and, in the diagram transformation |
| | function, the history of transformed matrices is |
| | stored in “Undo History”. |
| Redo | “Redo History” stores commands such that a redo |
| History | function can be performed after the undo function. |
| (6700) | “Redo History” has the same storage form as that of |
| | “Rendo History”. |
| cT | “cT” represents an Affinie matrix having a present |
| (6800) | transformation state. When performing diagram |
| | transformation, a transformation procedure is updated |
| | to the Affine matrix. “cT” is expressed as one matrix |
| | regardless of the type or the frequency number of the |
| | transformation. Although a value obtained through |
| | multiplication is substantially identical to the |
| | value of “cT” when matrices stored in “Undo history” |
| | are multiplied by each other, multiplying all |
| | matrixes by each other whenever a track is shown on a |
| | screen causes time loss. Accordingly, the value |
| | obtained through matrix multiplication is stored in |
| | order to avoid the reduction of a tracking speed. The |
| | track shown on the screen is obtained by multiplying |
| | coordinates of points forming an original track by |
| | “cT”. |
| bBox | “bBox” represents a bounding box of a present unit |
| (6900) | track. The bounding box of the present track is used |
| | for a tracker and a guide line for an enlargement/ |
| | reduction function when a diagram is transformed, and |
| | becomes important information when a selection region |
| | for a track is set. “bBox” is utilized as basic data |
| | for the operation used to display the optimum image |
| | suitable for a terminal display standard after |
| | information about the terminal display standard is |
| | determined in order to actively cope with various |
| | changes of display standards according to |
| | communication between various kinds of terminals. |

FIG. 11 is a view showing the structure of a handwritten track diagram group on a memory according to the present invention, and detailed parameters of the structure are shown in following table 2.

TABLE 2
Function of Handwritten track Diagram Object on Memory

| | |
|---|---|
| Class id | “Class id” has the type of an object. In this case, |
| (7100) | “Class id”has bit information representing a diagram |
| | group. |
| Color | “Color” is a temporary parameter having a grouped |
| (7200) | track color. Although the color of a diagram group is |
| | determined by colors of diagrams constituting the |
| | diagram group, the color check of all diagrams exerts |
| | a bad influence on an execution speed, so that the |
| | parameter of “Color” has a temporary result value. |
| | Differently from a diagram object, the diagram group |
| | may include diagrams having different colors, a white |
| | color in R, G, and B colors means “non-specified |
| | color”. In addition, another color that is not used |
| | may be specified as “non-specified color”according to |
| | applications |
| nDiagram | “nDiagam” represents the number of diagrams |
| (7300) | constituting the diagram group. |
| Diagrams | “Diagrams” represents the array of diagrams |
| (7400) | constituting the diagram group, and the diagrams may |
| | be unit track diagram objects or sub diagram groups. |
| | In other words, sub-groups (groups of a group) can be |
| | supported in the structure of the diagram group. |
| bBox | “bBox” represents the minimum bounding box capable of |
| (7500) | enclosing all tracks in the diagram group. In order |
| | to actively cope with various changes of display |
| | standards according to communication between various |
| | terminals, the information about the display standard |
| | and “bBox” are used as reference such that they are |
| | utilized as basic data for the operation used to |
| | display the optimum image suitable for the display |
| | specification. |

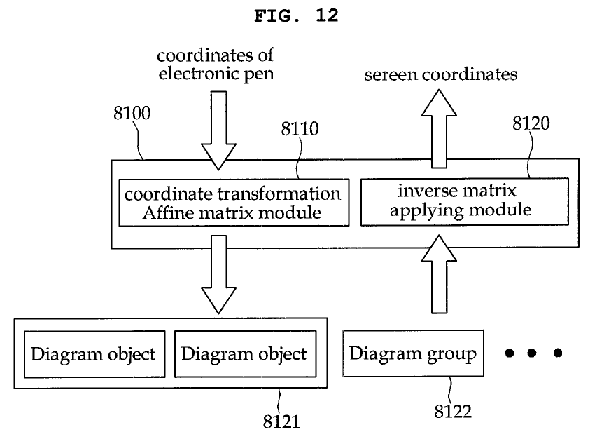

FIG. 12 is a view showing an algorithm for the image transformation of a handwritten track according to the present invention, and transformation of a coordinate system used to display a data coordinate system of handwritten track information on a screen.

Since transformations in a coordinate system is limited to parallel movement, rotation, and size change, all of the transformations may be expressed by using an Affine matrix. In addition, since the inverse coordinate transformation may be easily performed by employing the inverse matrix of the Affine matrix, the transformation from a screen coordinate system to a data coordinate system, and the transformation from the data coordinate system to the screen coordinate system can be expressed by using one Affine matrix.

In this case, original data of a handwritten track having a vector-type storage structure can be transformed only by changing the information about a transformation matrix and information about an image shape without causing damage to the original data when performing edit functions such as an enlargement or reduction function, a partial or whole extraction function, a deletion function, and a modification function. Accordingly, the original data of handwritten track information generated from an electrical pen in the first stage are preserved without causing damage to information even if track transformation and image shape transformation are repeatedly performed several times.

The enlargement, reduction, scrolling, portrait/landscape viewing functions for a screen image are performed through coordinate transformation for track data only when an image is output on a screen in a state in which the original track data are preserved. For example, regarding the edit function, when position information at coordinate (50,50) is displayed on a screen having a size reduced by 50%, the position information at (50,50) of the screen corresponds to the position information at (100, 100) in actual data coordinates. That is, the actual data coordinates are not identical to screen coordinates, so it is necessary to match a coordinate system for the electronic pen on the screen with a coordinate system of actual data whenever position information of the electronic pen is applied to data, causing inconvenience. If the above algorithm is employed for transformation, position information can be provided suitably for the screen.

Hereinafter, a detailed transformation algorithm will be described.

Regarding an algorithm for a handwritten track based on an Affine matrix transformation scheme, an Affine matrix is a 3×3 square matrix capable of representing the size change, rotation, and movement of a diagram. For example, when a track is rotated at an angle of 90 degrees, each point forming the track is multiplied by

$$[ \begin{matrix}0 & 1 & 0 \\ - 1 & 0 & 0 \\ 0 & 0 & 1\end{matrix} ] ,$$

thereby obtaining a track rotated by an angle of 90 degrees.

In addition, the Affine matrix can represent sequence transformation for size, rotation, and movement of a diagram as one matrix. For example, on the assumption that matrices representing movement and rotation transformation are M₁ and M₂, a new track after the movement and rotation transformation may be obtained by multiplying each point: of the track with a matrix of M (herein, M=M₂M₁).

Meanwhile, when storing information, although the Affine matrix is a 3×3 matrix, since the third row is fixed as [0 0 1], only six parameters are stored in order to store the Affine matrix.

In addition, a size transformation matrix is as follows.

1) Size Transformation using upper left end tracker

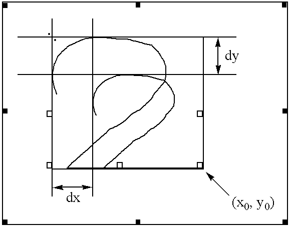

When the width and height of a bounding box of an original diagram is referred to as “weight” and “height”, a matrix, M₁, enabling coordinate transformation such that lower left end coordinates of the bounding box are coordinates of an origin may be represented as

$${M}_{1} = [ \begin{matrix}0 & 1 & - {x}_{0} \\ - 1 & 0 & - {y}_{0} \\ 0 & 0 & 1\end{matrix} ] .$$

When an x-directional size transformation ratio and a y-directional size transformation ratio are represented as “xratio” and “yratio”,

$${x}^{⊥} ratio = \frac{width + dx}{width} , y ratio = \frac{height + dy}{height} .$$

Accordingly, a size transformation matrix, M₂, may be represented as

$$[ \begin{matrix}x ratio & 1 & 0 \\ 0 & y ratio & 0 \\ 0 & 0 & 1\end{matrix} ] .$$

In addition, when a matrix, M₃, for originally recovering a coordinate system may be represented as

$$[ \begin{matrix}1 & 0 & {x}_{0} \\ 0 & 1 & {y}_{0} \\ 0 & 0 & 1\end{matrix} ] ,$$

a matrix for representing size transformation by an upper left end tracker may be represented as T=M₃M₂M₁.

2) Size Transformation using Upper end tracker

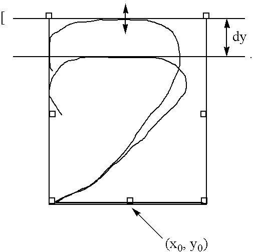

When the width and height of a bounding box of an original diagram is referred to as “width” and “height” a matrix, M₁, enabling coordinate transformation such that coordinates of a central point of a lower end of the bounding box are coordinates of an origin may be represented as

$$[ \begin{matrix}1 & 0 & - {x}_{0} \\ 0 & 1 & - {y}_{0} \\ 0 & 0 & 1\end{matrix} ] .$$

When a y-directional size transformation ratio is represented as

$$y ratio = \frac{height + dy}{height} .$$

Accordingly, a size transformation matrix, M₂, may be represented as

$$[ \begin{matrix}1 & 0 & 0 \\ 0 & y ratio & 0 \\ 0 & 0 & 1\end{matrix} ] .$$

In addition, a matrix, M₃, for originally recovering a coordinate system may be represented as

$$[ \begin{matrix}1 & 0 & {x}_{0} \\ 0 & 1 & {y}_{0} \\ 0 & 0 & 1\end{matrix} ] .$$

Therefore, a matrix representing size transformation by the upper end tracker may be T=M₃M₂M₁, and a size transformation matrix by six remaining trackers has a similar format.

The rotation transformation matrix is as follows.

1) Rotation transformation using upper right side tracker

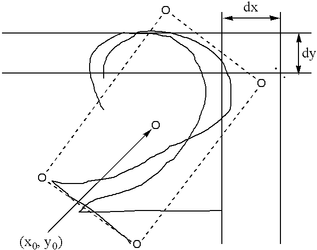

When the width and height of a bounding box of an original diagram is referred to as “width”? and “height”, a matrix, M₁, allowing coordinates of a central point of a lower end of the bounding box to be transformed as coordinates of an origin may be represented as

$$[ \begin{matrix}1 & 0 & - {x}_{0} \\ 0 & 1 & - {y}_{0} \\ 0 & 0 & 1\end{matrix} ] .$$

When a rotation angle is defined as a

$$angle = {tan}^{- 1} ( \frac{dy}{dx} ) ,$$

a rotation transformation matrix, M₂, may be represented as

$${}^{[} [ \begin{matrix}cos ( angle ) & sin ( angle ) & 0 \\ - sin ( angle ) & cos ( angle ) & 0 \\ 0 & 0 & 1\end{matrix} ] .$$

In addition, a matrix, M₃, for originally recovering a coordinate system may be represented as

$$[ \begin{matrix}1 & 0 & {x}_{0} \\ 0 & 1 & {y}_{0} \\ 0 & 0 & 1\end{matrix} ] .$$

Therefore, a matrix for representing rotation transformation by the upper end tracker may be T=M₃M₂M₁, and a rotation transformation matrix by three remaining trackers has a similar format.

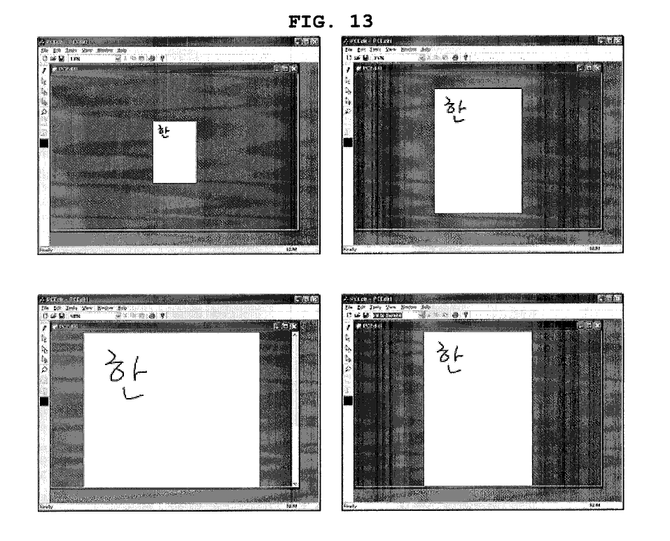

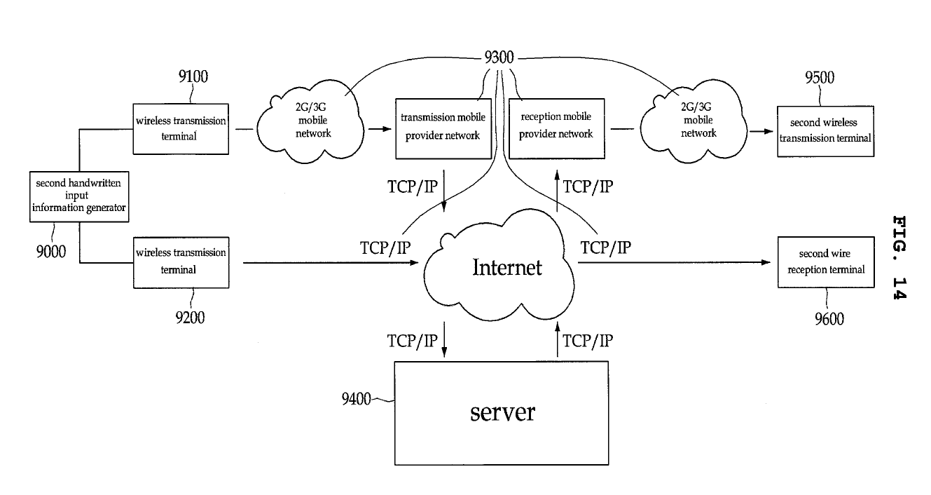

FIG. 13 is a view showing a screen size and screen resolution in enlargement/reduction for a handwritten image according to the present invention, in which a screen adjustment function is provided to enlarge/reduce a handwritten image displayed on a terminal and display the handwritten image according to a screen size and screen resolution suitable for the standard of a terminal display for the convenience of a user.

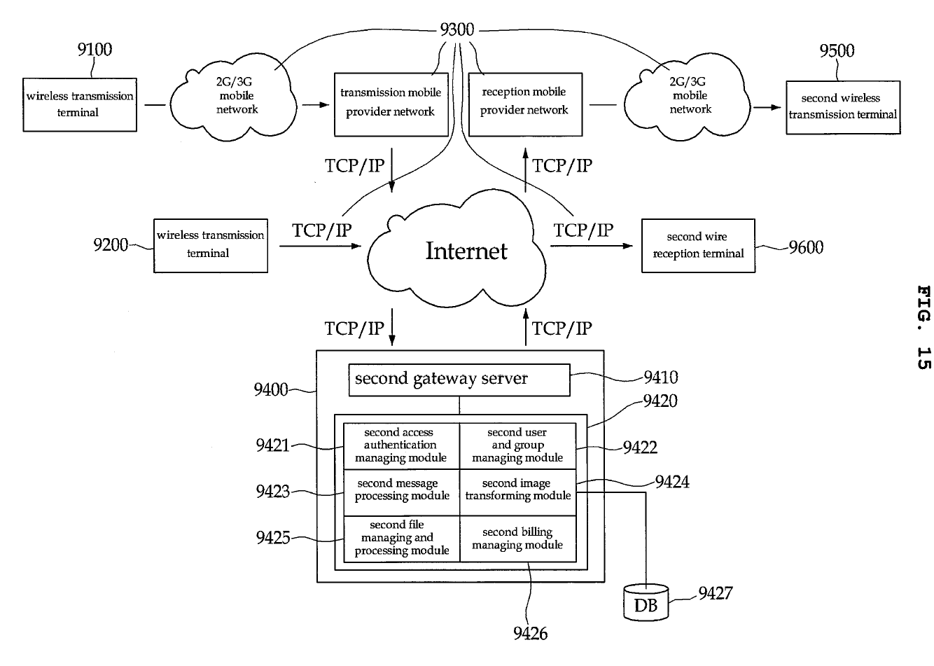

FIG. 14 is a block diagram showing the structure of a wireless and/or wire handwriting instant messenger system that transmits message information according to the present invention. In the structure, handwritten track information created by a user using an electronic pen is transformed into a predetermined format through a second handwritten input information generator 9000 so that a second wireless transmission terminal 9100 such as a mobile telephone terminal or a second wire transmission terminal 9200 such as a PC, a notebook, and a digital TV transmits the handwritten track information to a second server 9400 through a wire/wireless hybrid network 9300 including a 2G/3G mobile network or a wire network such as the ultra-speed Internet and a digital TV network. In this case, the handwritten track information is transmitted to a second wireless reception terminal 9500 or a second wire reception terminal 9600 through the second server 9400.

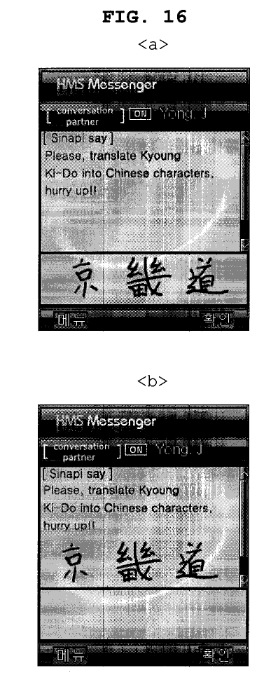

FIG. 15 is a block diagram showing the second server 9400 of the wire and/or wireless handwriting instant messenger system, in which the second server 9400 includes a second gateway server 9410, a second access authentication managing module 9421, a second user and group managing module 9422, a second message processing module 9423, a second image transforming module 9424, a second file managing and processing module 9425, a second billing managing module 9426, and a database 9427. The second gateway server 9410 manages the cooperation with a system related to the wireless Internet that is operated by a mobile service provider, or a wire Internet system. The second access authentication managing module 9421 determines if a user is authenticated to manage an access approval state of the user. The second user and group managing module 9422 allows a user and another users belonging to a group related to the user to share information about their access state between them. In addition, the second user and group managing module 9422 creates a new group or deletes an existing group. The second message processing module 9423 manages details for facilitating message communication between authenticated users. The second image transforming module 9424 transforms an image of a handwritten message into image data having a typical image format such as a joint photographic experts group (JPG) or bitmap (BMP) for the sake of a receiver having no handwriting instant messenger function according to the present invention or a receiver under the environment in which the handwriting instant messenger function is not driven. The second file managing and processing module 9425 stores and processes a file generated when message communication is made between a transmitter and a receiver. The billing managing module 9426 manages details of billing according to the benefit of a handwriting instant message service according to the present invention. The second database 9427 is used to perform maintenance and management suitable for the wire and/or wireless handwriting instant messenger system.

The access authentication managing module 9421 cooperates with the terminal log-in authentication module 2121 of the first wireless transmission or reception terminal 2100 or 5100 to determine if a user is authenticated when the user logs in a handwriting instant messenger service according to the present invention. In other words, the access authentication managing module 9421 receives a user ID and a password from the terminal log-in authentication module 2121 to determine if the user ID and the password are authenticated and to perform a response function.

If information about “version Up” exists, the information about “version Up” and an upgrade program are provided to the first wireless transmission and reception terminals 2100 and 5100. In addition, if information about “success” or “failure” is received in relation to the transmission of a message or a file, a response message thereto is transmitted to the first wireless transmission and reception terminals 2100 and 5100.

The user and group managing module 9422 cooperates with the conversation partner and conversation group managing module 2122a and the personal information managing module 2122b of the management function module 2122 in the first wireless transmission or reception terminal 2100 or 5100 to add a conversation partner or a conversation group for the handwriting instant messenger service, move the conversation partner into another group, or block or delete a specific conversation partner. In detail, the user and group managing module 9422 provides information about a conversation partner who has already joined to the handwriting instant messenger service to the first wireless transmission or reception terminal 2100 or 5100, adds the information, or blocks or deletes a specific conversation partner. The user and group managing module 9422 cooperates with the personal information managing module 2122b of the management function module 2122 in the first wireless transmission or reception terminal 2100 or 5100, and thus synchronizes with the first wireless transmission or reception terminal 2100 or 5100 in relation to user call or connection information, such as a user ID, a user name, a nick name, a password, an e-mail, a FAX number, and a phone number, for all user groups when using the handwriting instant messenger service such that the first wireless transmission or reception terminal 2100 or 5100 can maintain updated information.

The message processing module 9423 cooperates with the instant messenger conversation function module 2123a of the first wireless transmission or reception terminal 2100 or 5100, and thus receives a command for the transmission of a handwriting data file in the form of a memo or a note to a single receiver or a plurality of receivers from a transmitter so that the file can be directly transmitted to a terminal of the counterpart in the reception side. In addition, the message processing module 9423 transmits the file to the reception terminal through an e-mail or a Fax.

The file managing and processing module 9425 continuously stores a handwritten data file that has been transmitted through the first and second network interface modules 2160 and 2260 of the first transmission and reception terminals 2100 and 5100 within capacities of storage spaces previously assigned to users in transmission and reception sides, or automatically and integrally deletes the handwritten data file after a predetermined period lapses. In particular, the second file managing and processing module 9425 can assign separated storage spaces for file sharing between the users by sharing portions of storage spaces assigned to users within the capacity of the assigned storage spaces according to the demands of the users in the reception and transmission sides. Further, in order to store information such as various schedules of appointments, or important memos and various announcements of a user or a specific group of the user that have been created in the schedule management function module 2123c of the first transmission or reception terminal 2100 or 5100, the second file managing and processing module 9425 allocates a specific storage space allowing the user group to share information such as conference records in the user group. In this case, if a new handwritten data file to be shared is created, each user belonging to the use group can automatically download the new handwritten data file and perform synchronization when the user accesses the handwriting instant messenger service network according to the present invention.

FIG. 16 shows screens of a portable appliance when writing a message through a wire and/or wireless handwriting instant messenger system according to the present invention. In other words, <a> and <b> of FIG. 16 show a case in which two concerned parties make message communication through a wire and/or wireless handwriting instant messenger service according to the present invention by using cellular phones.

In detail, as shown in <a> of FIG. 16, Sinipi who is the first party transmits a message of “Please, translate Kyong Ki-Do into Chinese characters, hurry up” to Yong. J who is the second party. In other words, Sinip asks Yong. J a question that what is Chinese characters of Kyong Ki-Do.

Thereafter, as shown in <b> of FIG. 16, Yon. J who is the second party transmits a message to Sinip who is the first party by translating Kyong Ki-DO into Chinese characters, [symbol] In general, the expression using Chinese characters is impossible or restricted in a handheld phone based on the Korean language. However, when using a wire and/or wireless handwriting instant messenger service according to the present invention, a message based on Chinese characters can be delivered through a wire and/or wireless network as if a user personally writes Chinese characters by using a pen and then shows it to the second party.

1. A system for transmitting handwriting instant messages through a wire and/or wireless network, the system comprising:
a handwritten input information generating module for generating a position detection signal based on movement of an electronic pen, transforming the signal into vector-type handwritten input information, and then transmitting the handwritten input information;
a transmission terminal receiving the handwritten input information from the handwritten input information generating module and creating handwritten instant message information based on the handwritten input information to transmit the handwritten instant message information to an external network through a wire or wireless network;
a server receiving the handwritten instant message information through the wire or wireless network and transmitting the handwritten instant message information to a receiver to provide a handwritten instant message service; and
a reception terminal for receiving the handwritten instant message information transmitted through the server.

2. The system as claimed in claim 1, wherein the handwritten input information generating module comprises:
an electronic pen module for generating pen pressure information and a position signal including first and second reference signals; and
a digital position information generating module for detecting the position signal to transform the position signal into vector-type handwritten input information and processing the pen pressure information.

3. The system as claimed in claim 2, wherein the electronic pen module comprises:
a first reference signal transmitting module for creating a first reference signal provided with one of a radio frequency (RF) signal and an infrared signal;
a pen pressure information detecting module for detecting pen pressure applied in handwriting, converting the pen pressure into predetermined information, and transmitting the information with the first reference signal by adding the information to the first reference signal through a modulation process;
a second reference signal transmitting module for creating a second reference signal having a propagation speed slower than a propagation speed of the first reference signal; and
a power supplying module for supplying power to each module.

4. The system as claimed in claim 2, wherein the digital position information generating module comprises:
a first reference signal receiving module for receiving the first reference signal;
a second reference signal receiving module for receiving the second reference signal;
a data processing module calculating a position of the electronic pen module based on a difference in arriving times of each second reference signal at the second reference signal receiving module with reference to the arriving time of the first reference signal at the first reference signal receiving module, and then transforming the calculated position into the vector-type handwritten input information; and
a terminal interface module used to transmit the handwritten input information to the transmission terminal through a wire or wireless data communication scheme,
wherein at least two second reference signal receiving modules are provided while being spaced apart from each other by a predetermined distance.

5. The system as claimed in claim 4, wherein the digital position information generating module further comprises a sub-memory module capable of storing the handwritten input information.

6. The system as claimed in claim 4, wherein the data processing module of the digital position information generating module further comprises a function of converting the pen pressure information transmitted through the first reference signal into a predetermined data formation through a demodulation process.

7. The system as claimed in claim 1, wherein the transmission and reception terminals include any one selected from the group consisting of a portable phone, a wireless computer, a PDA, a smart phone, a WiBro terminal, a ground-wave DMB terminal, a satellite DMB terminal, a cable computer, a cable phone, and a digital TV settop box.

8. The system as claimed in claim 7, wherein the transmission terminal comprising:
a peripheral device interface module connected with the handwritten input information generating module through a wire or wireless data communication scheme;
a processing module for providing operation functions used to drive the transmission terminal;
an application module for selectively driving at least one of a game, an electronic dictionary, an electronic calculator, an electronic note, a handwritten recognition program, a voice recognition program, and MP3 and moving picture reproduction;
a terminal operating module for controlling the application module;
a display module for displaying handwritten instant message information on a screen;
a storage module for storing the handwritten input information;
a network interface module for transmitting the handwritten input information to the server through an external network; and
a handwritten message processing module cooperating with the server to operate and provide a wire and/or wireless instant messenger service.

9. The system as claimed in claim 8, wherein the handwritten message processing module comprises:
a terminal log-in authenticating module for determining a user having a right to use the wire and/or wireless instant messenger service;
a management function module, which is synchronized with the server to allow the user to recognize a state of a conversation partner specified by the user, and process transmitted/received handwritten instant message information in cooperation with the server; and
a service function module cooperating with the server to provide various handwriting instant messenger services.

10. The system as claimed in claim 9, wherein the terminal log-in authenticating module provides two text boxes to allow the user to input a user identifier (ID) and a password for user registration.

11. The system as claimed in claim 10, wherein the user inputs the user ID and the password into the text boxes of the terminal log-in authenticating module only when the user uses a handwriting instant messenger service for the first time.

12. The system as claimed in claim 9, wherein the management function module comprises:
a conversation partner- or conversation group-managing module for adding a conversation partner or a conversation group, with which the user make conversation through a handwriting instant messenger, or blocking and deleting a specific conversation partner or a specific conversation group;
a personal state information managing module for allowing the user to set information about an access state of the user such that the access state of the user is automatically or optionally delivered to the conversation partner or the conversation group and storing personal log-in information for a handwriting instant messenger service such that the log-in information is automatically input when the user accesses the handwriting instant messenger service; and
a file managing module for storing and managing information relating to a handwriting instant messenger.

13. The system as claimed in claim 12, wherein the personal state information managing module has information about a standard of a display provided in the transmission terminal to provide information for realizing a screen adjustment function when the handwritten input information is displayed on a screen of the transmission terminal.

14. The system as claimed in claim 9, wherein the service function module comprises:
an instant messenger conversation function module cooperating with the terminal log-in authenticating module and the management function module of the server to provide a user interface function which is required for the user to use the handwriting instant messenger service;
a data file authoring function module for providing a user interface function having a form of a memo pad or a notebook such that a handwritten input information file is output or reproduced, or the handwritten input information file is transmitted to the conversation partner or the conversation group such that the conversation partner or the conversation group easily outputs or reproduces the handwritten input information file; and
a schedule management function module cooperating with the server to allow a user to store information about appointments or memos relating to the user and a group in the terminal of a user by inputting handwritten input information into an input format which represents dates, hours, and minutes in such a manner that the information about the appointments and the memos is shared through a file managing and processing module of the server.

15. The system as claimed in claim 14, wherein the schedule management function module allows the user to share the handwritten input information prepared in date, hour and minute units with all users, a specific user, or specific plural users belonging to the group in the cooperation with the server.

16. The system as claimed in claim 14, wherein the schedule management function module stores handwritten input information, which is obtained through inputting a schedule on specific time in future in a form of a memo or a note, in at least one of the terminal and the server, and allows the user to recognize the handwritten input information through one of a ringing sound and a message if the specific time arrives.

17. The system as claimed in claim 1, wherein the server comprises:
a gateway module cooperating with a wireless or wire data network to manage a connection state between the transmission and reception terminals and the server and to process transmission and reception commands for wire and/or wireless handwriting instant messenger data between specific transmission and reception terminals;
a main server system for managing an access approval for a subscriber and storing and managing information of a user or a group of the user while transforming an image and managing a handwritten message data file; and
a database module.

18. The system as claimed in claim 17, wherein the main server system comprises:
an access authentication managing module for determining a subscriber authentication state to manage the access approval for the subscriber in cooperation with the terminal log-in authenticating module of the terminal;
a user and group managing module enabling the user and the group to share an access state of an authenticated subscriber and access states of other users belonging to the group, and managing creation of a new group and deletion of the group;
a message processing module for sequentially processing message transmission/reception between authenticated users; and
a file managing and processing module for storing and processing a file created through handwritten message communication between users.

19. The system as claimed in claim 18, wherein the main server system further comprises at least one of:
an image transforming module for transforming handwritten input information into an image file for a user who is not joined to the wire and/or wireless handwriting instant messenger service; and
a billing managing module for managing details of billing caused by the wire and/or wireless handwriting instant messenger service.

20. The system as claimed in claim 18, wherein the file managing and processing module comprises functions of:
continuously storing handwritten input information within a capacity of a storage space previously assigned to a user in a reception side;
automatically deleting the handwritten input information after a predetermined period lapses;
setting options of the storage function and the deletion function; and
allocating randomly assigned information share storage for plural users used for file sharing between users by using some portions of storage capacity, which is assigned to the users according to demand of the users in transmission and reception sides, within the capacity of the storage capacity.

21. The system as claimed in claim 1, wherein the transmission and reception terminals have a same structure and function, and are driven in one terminal equipment.

22. The system as claimed in claim 1, wherein the reception terminal comprises:
a peripheral device interface module for receiving the handwritten input information to make communication with an external output device through one of wire and wireless communication schemes;
a processing module for providing an operation function used to drive the reception terminal;
an application module for selectively operating at least one of a game function using the electronic pen, an electronic dictionary employing a handwriting input scheme, an electronic calculator employing a handwriting input scheme, an electronic note employing a handwriting input scheme, a handwritten recognition program, a voice recognition program, and an MP3 and moving picture reproduction function;
a terminal operating module for controlling the application module;
a display module for receiving handwritten instant messenger information from the transmission terminal through the server and displaying the handwritten instant messenger information suitably for a screen;
a storage module for storing the handwritten input information as a data file having a predetermined format;
a network interface module used to receive the handwritten input information through a network employing one of wire and wireless schemes; and
a handwritten message processing module cooperating with the server to provide the wire and/or wireless handwriting instant messenger service.

23. A method for providing a wire and/or wireless handwriting instant messenger service, the method comprising the steps of:
(1) creating structure information about a unit track object diagram for a track handwritten by using an electronic pen; and
(2) grouping the unit tract object diagram to create structure information of a track diagram group.

24. The method as claimed in claim 23, wherein step (1) comprising the steps of:
(1) inputting contents through a handwriting scheme by using the electronic pen;
(2) creating a first reference signal using one of a radio frequency and an infrared ray and a second reference signal having a propagation speed slower than a propagation speed of the first reference signal as position signals when the contents are input by using the electronic pen;
(3) creating coordinate information by calculating the coordinate information about a handwritten track based on arriving time of the second reference signal to at least two reference signal receiving modules after the first reference signal has arrived at a first reference signal receiving module;
(4) creating information about a minimum bounding box enclosing a whole range of a unit tract object diagram corresponding to the created coordinate information; and
(5) creating information about initial track transformation of the unit tract object diagram provided through an Affine matrix equation having a 3×3 square matrix structure.

25. The method as claimed in claim 23, wherein step (2) comprising the steps of:
(1) grouping the structure information about a plurality of the unit tract object diagrams to create the structure information about the track diagram group; and
(2) creating the structure information about the track diagram group by inserting initial track transformation information of the tack diagram group and information about the minimum bounding box, which includes number information of object diagram groups and a range of a unit track object diagram group, into the structure information about the track diagram group.

26. The method as claimed in claim 24, wherein step (2) further comprises a step of detecting pen pressure applied by the electronic pen, transforming the pen pressure into predetermined pen pressure information, and then carrying the pen pressure information with the first reference signal through a modulation scheme.

27. The method as claimed in claim 23, wherein step (1) further comprises a step of inputting image color information for the unit track object diagram.

28. A server of a wire and/or wireless handwriting instant messenger service system, which receives handwritten input information obtained by creating a position recognition signal using an electronic pen and transforming the position recognition signal into vector-type handwritten input information and transmits the handwritten input information to a receiver, thereby performing a handwriting instant messenger service, wherein
the handwritten input information is transformed into a handwritten instant message by a transmission terminal and then received in the server through a wire network or a wireless network, and
the handwritten input information transmitted to the receiver through the server is information about the transformed handwritten instant message information.
